(19) United States
(12) Patent Application Publication
(10) Pub. No.: US 2026/0230845 A1
(43) Pub. Date: Aug. 6, 2026

(54) METHODS TO SUPPORT AIML FALLBACK OPERATION

(71) Applicant: InterDigital Patent Holdings, Inc., Wilmington, DE (US)

(72) Inventors: Dylan Watts, Montreal (CA); Ghyslain Pelletier, Montreal (CA); Patrick Tooher, Montreal (CA); Oumer Teyeb, Montreal (CA); Yugeswar Deenoo Narayanan Thangaraj, Chalfont, PA (US); Brian Martin, Farnham (GB); Virgil Comsa, Montreal (CA); James Miller, Northport, NY (US)

(73) Assignee: InterDigital Patent Holdings, Inc., Wilmington, DE (US)

(21) Appl. No.: 19/044,478

(22) Filed: Feb. 3, 2025

(51) Int. Cl. H04W 24/02; H04L 41/16

(52) U.S. Cl. CPC H04W 24/02; H04L 41/16

(57) ABSTRACT

A method may be implemented by a wireless transmit/receive unit (WTRU), including receiving information indicating first applicability conditions and a first configuration for a first artificial intelligence or machine learning (AIML) model category and second applicability conditions and a second configuration for a second AIML model category. It may be determined whether the first AIML model category is applicable to a cell based on the first applicability conditions and first configuration, and whether the second AIML model category is applicable based on the second applicability conditions and second configuration. A report may be sent indicating applicability of the first AIML model category and second AIML category to the cell. It may be determined that the first AIML model category is no longer applicable based on the first configuration. An indication that indicates that the first AIML model category is no longer applicable to the cell may be sent.

### BACKGROUND

3rd Generation Partnership Project (3GPP) has recently begun integrating Artificial Intelligence/Machine Learning (AIML) into Fifth-Generation New Radio (5G NR) to enhance air-interface performance (e.g., improved throughput, robustness, accuracy, and/or reliability) and/or reduce complexity and/or overhead. Selected features may include AIML for beam management, positioning, and/or Channel State Information (CSI) prediction, based on an assessment of their performance in comparison with traditional methods and the associated potential specification impact.

Consideration of multiple features may enable a common Artificial Intelligence/Machine Learning (AIML) management framework, which may include aspects related to signaling and protocol aspects of Life Cycle Management (LCM). The framework may include necessary signaling and/or mechanisms for LCM to facilitate model training, inference, performance monitoring, and/or data collection for both Wireless Transmit/Receive Unit (WTRU)-sided and network (NW)-sided models. Additionally, and/or alternatively, the framework may include signaling mechanisms for applicable functionalities and/or models.

### SUMMARY

A wireless transmit/receive unit (WTRU) may include a processor. The processor may be configured to receive information indicating first applicability conditions for a first artificial intelligence or machine learning (AIML) model category and second applicability conditions for a second AIML model category, and a first configuration associated with the first AIML model category and a second configuration associated with the second AIML model category. The processor may be configured to determine whether the first AIML model category is applicable to a cell based on the first applicability conditions and the first configuration, and whether the second AIML model category is applicable to the cell based on the second applicability conditions and the second configuration. The processor may be configured to send a report indicating applicability of the first AIML model category to the cell and indicating applicability of the second AIML model category to the cell. The processor may be configured to determine that the first AIML model category is no longer applicable to the cell based on the first configuration. The processor may be configured to send an indication that indicates that the first AIML model category is no longer applicable to the cell.

The processor may be configured to perform inference using a model of the first AIML category based on the first configuration in response to determining that the first AIML category is applicable to the cell. The processor may be configured to perform inference using a model of the second AIML category based on the second configuration in response to determining that the first AIML category is no longer applicable to the cell.

The first applicability conditions may include a first indication of one or more of: a number of Transmission-Reception Points (TRPs), a number of antennas, an antenna tilt, a polarization of an antenna, a beam, a geographic area, or a time-period. The second applicability conditions may include a second indication of one or more of: a number of Transmission-Reception Points (TRPs), a number of antennas, an antenna tilt, a polarization of an antenna, a beam, a geographic area, or a time-period.

The first AIML model category may be associated with a different prediction time horizon, a different prediction confidence level, a different processing requirement, and may be configured for a different frequency, a different cell, a different location, or a different time of day as compared to the second AIML model category.

The report may include a list of one or more cells in which at least one AIML model category is applicable based on the first configuration or the second configuration.

The report may include a request to receive multiple configurations for at least one of the first AIML model category and the second AIML model category. The multiple configurations may include the first configuration and the second configuration.

The report may include an indication of a preference indicating which of the first configuration or the second configuration is to be initially activated, and which is to be stored as a fallback configuration.

The processor may be configured to perform AIML inference according to the first configuration until the first AIML model category is determined to be no longer applicable. The indication that the first AIML model category is no longer applicable may indicate that the WTRU may use the second configuration associated with the second AIML model category.

The processor may be configured to determine that the first AIML model category is no longer applicable based on at least one of mobility of the WTRU to a different cell, a change in network-side applicability conditions, or an update in model availability.

The first configuration may include configuration information enabling inference using an AIML model trained on first network conditions. The second configuration may include configuration information enabling inference using an AIML model trained on second network conditions.

A method may be implemented by a wireless transmit/receive unit (WTRU), including receiving information indicating first applicability conditions for a first artificial intelligence or machine learning (AIML) model category and second applicability conditions for a second AIML model category, and a first configuration associated with the first AIML model category and a second configuration associated with the second AIML model category. It may be determined whether the first AIML model category is applicable to a cell based on the first applicability conditions and the first configuration, and whether the second AIML model category is applicable to the cell based on the second applicability conditions and the second configuration. A report may be sent indicating applicability of the first AIML model category to the cell and indicating applicability of the second AIML model category to the cell. It may be determined that the first AIML model category is no longer applicable to the cell based on the first configuration. An indication that indicates that the first AIML model category is no longer applicable to the cell may be sent.

The method may include performing inference using a model of the first AIML category based on the first configuration in response to determining that the first AIML category is applicable to the cell. The method may include performing inference using a model of the second AIML category based on the second configuration in response to determining that the first AIML category is no longer applicable to the cell.

The first applicability conditions may include a first indication of one or more of: a number of Transmission-Reception Points (TRPs), a number of antennas, an antenna tilt, a polarization of an antenna, a beam, a geographic area, or a time-period. The second applicability conditions may include a second indication of one or more of: a number of Transmission-Reception Points (TRPs), a number of antennas, an antenna tilt, a polarization of an antenna, a beam, a geographic area, or a time-period.

The first AIML model category may be associated with a different prediction time horizon, a different prediction confidence level, a different processing requirement, and may be configured for a different frequency, a different cell, a different location, or a different time of day as compared to the second AIML model category.

The report may include a list of one or more cells in which at least one AIML model category is applicable based on the first configuration or the second configuration.

The report may include a request to receive multiple configurations for at least one of the first AIML model category and the second AIML model category. The multiple configurations may include the first configuration and the second configuration.

The report may include an indication of a preference indicating which of the first configuration or the second configuration is to be initially activated, and which is to be stored as a fallback configuration.

The method may include performing AIML inference according to the first configuration until the first AIML model category is determined to be no longer applicable. The indication that the first AIML model category is no longer applicable may indicate that the WTRU may use the second configuration associated with the second AIML model category.

The method may include determining that the first AIML model is no longer applicable may be based on at least one of mobility of the WTRU to a different cell, a change in network-side applicability conditions, or an update in model availability.

The first configuration may include configuration information enabling inference using an AIML model trained on first network conditions. The second configuration may include configuration information enabling inference using an AIML model trained on second network conditions.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating a method for managing AIML functionality and supporting AIML fallback operations.

### DETAILED DESCRIPTION

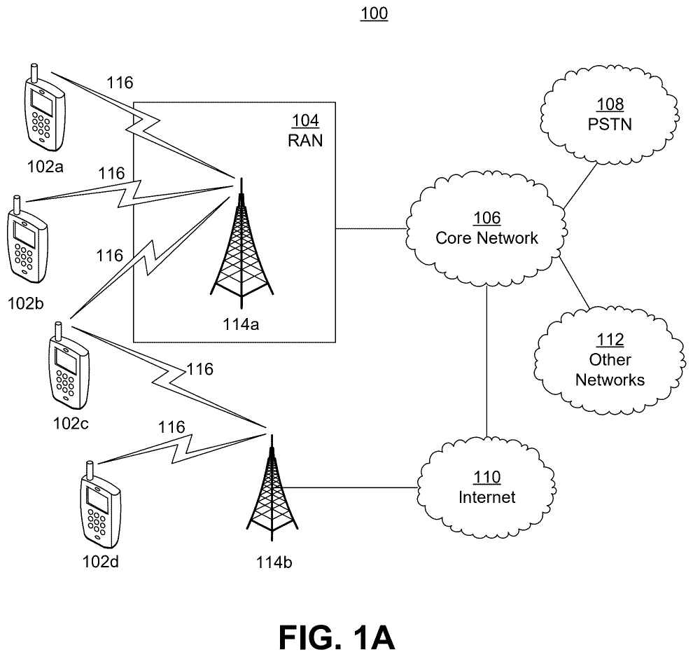

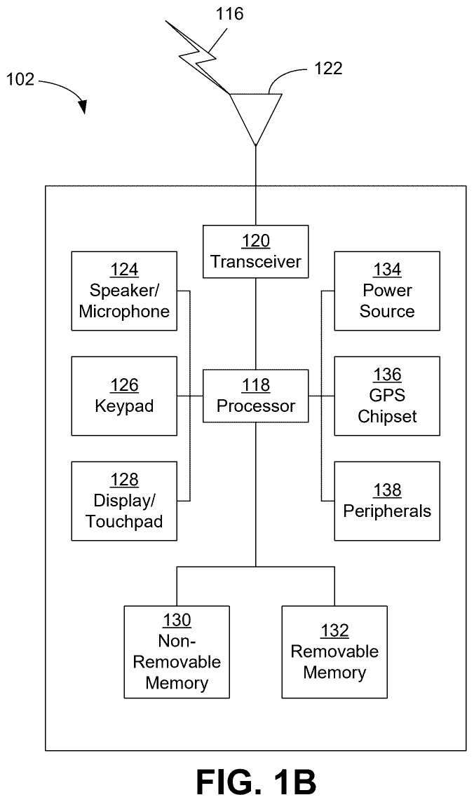

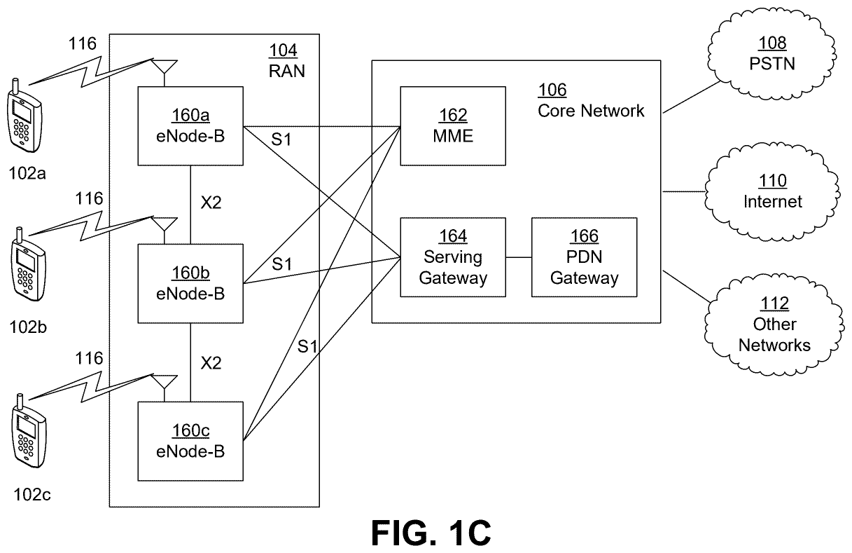

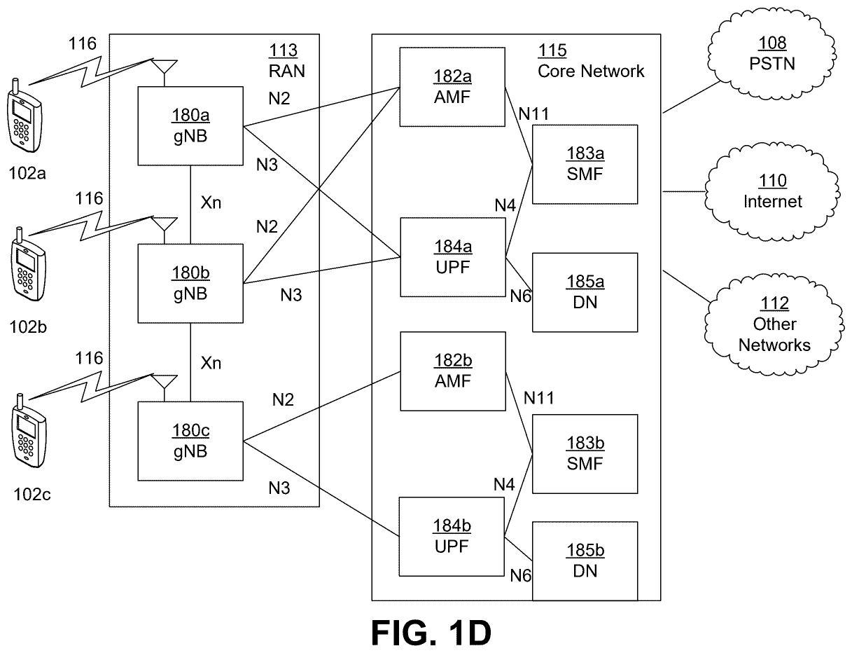

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A Wireless Transmit/Receive Unit (WTRU) may be utilized to maintain different tiers for an Artificial Intelligence/Machine Learning (AIML) functionality, where each tier may correspond to differences in functionality applicability, performance, power consumption, and/or processing consumption. The WTRU may report different tiers of applicability for a given AIML functionality (e.g., corresponding to the use of different AIML models for the functionality). Additionally, and/or alternatively, the WTRU may report information related to the applicability tier (e.g., expected performance, capability, inference latency, and/or applicability in one or more neighboring cells). The WTRU may request multiple configurations for a given AIML functionality (e.g., to support input for a different AIML model). Additionally, and/or alternatively, the WTRU may recommend one or more configurations necessary to operate the functionality according to a tier and may indicate a preference regarding which configurations to store (e.g., as a fallback configuration) and which to activate.

A Wireless Transmit/Receive Unit (WTRU) may switch between multiple pre-configured configurations for a given Artificial Intelligence/Machine Learning (AIML) functionality (e.g., based on the WTRU using a different AIML model to perform inference). Model switching may be based on applicability of a model, performance, and/or a network request. Additionally, and/or alternatively, the WTRU may notify and/or request from the network to apply a different AIML configuration, including possible differences in performance and/or inference latency. The WTRU may fall back to non-AIML operation (e.g., based on the lack of an applicable alternative stored configuration and/or poor performance). Additionally, and/or alternatively, the WTRU may be prohibited from switching to an alternative AIML configuration.

The current AIML framework may consider functionality-based LCM, where a functionality may refer to an AIML feature enabled by one or more configurations. A network may indicate activation, deactivation, fallback, and/or switching of AIML functionality via 3GPP signaling (e.g., RRC, MAC-CE, and/or DCI). To support configuration and/or (de)activation of a functionality, a WTRU may report whether a functionality is applicable based on WTRU and/or network-side additional conditions (e.g., WTRU speed, number of antennas, and/or model availability at the WTRU). A WTRU may first be provided an AIML configuration and report whether the functionality is applicable based on the configuration, or the WTRU may report one or more applicable functionalities and subsequently receive an AIML configuration.

LCM may be model-ID based, where models may be identified at the network, and the network and/or WTRU may activate, deactivate, select, and/or switch individual AIML models via a model ID. In model-ID-based LCM, the network may explicitly control which particular model is used for a given AIML functionality. For example, the WTRU may provide details of AIML models and their capabilities, and the network may determine which model to activate for a particular functionality.

Different AIML model structures and training data may provide AIML models with varying levels of accuracy, sensitivity to applicability conditions, and/or WTRU power and/or processing requirements. For example, an AIML model trained on a narrow data set (e.g., a detailed model) may yield high-accuracy inference predictions within a specific range; however, the model may be sensitive to changing applicability conditions (e.g., upon cell mobility). Alternatively, an AIML model trained on a wide data set (e.g., a general model) may apply to a broad range of applicability conditions; however, it may provide lower inference accuracy for a given range. Additionally, and/or alternatively, general models may be large in scale, requiring additional WTRU processing and/or power consumption to operate.

Always using a detailed model may yield high-accuracy inference; however, due to the limited applicability range, frequent model switching may be required, increasing LCM signaling overhead and potentially interrupting AIML service continuity. LCM signaling may be reduced by using a general AIML model; however, this may come at the expense of AIML accuracy and increased WTRU power and/or processing consumption.

Proper AIML operation may require a balance between inference accuracy, AIML service continuity, and WTRU processing and/or power consumption. A WTRU may maintain multiple models (e.g., detailed and general) to support a given functionality and may switch between models based on what is most important at a given moment. Since AIML in 3GPP may be functionality-based, details of the AIML model used for a given functionality may not be known to the network. Coordination may therefore be required to receive an updated configuration to support the newly applied AIML model (e.g., a new set of measurement resources). To avoid potential AIML service disruption, applying the revised configuration may require minimal time.

A WTRU may report the capability and applicability of one or more AIML functionalities to the network. The WTRU may receive a corresponding configuration to enable the AIML functionality. If an AIML functionality becomes non-applicable, the WTRU may report non-applicability to the network, and the network may then deactivate the corresponding functionality.

Currently, there may be no defined concept for switching between detailed and general AIML models and/or functionalities. Additionally, there may be ongoing discussion, but no agreement, regarding fallback to a legacy model and/or another AIML model or functionality.

To balance AIML service continuity with prediction accuracy under changing applicability conditions, a WTRU may report the applicability of an AIML functionality and configuration information required for a first and second category of AIML operation. The WTRU may receive a first configuration to support AIML operation according to a first category (e.g., a configuration to support a detailed AIML model) and a second configuration to support AIML operation according to a second category (e.g., configuration information to support a general AIML model). The WTRU may perform AIML operation according to the first configuration and may store the second configuration (e.g., as a fallback). The WTRU may determine that it can no longer perform AIML operation according to the first configuration (e.g., as a function of mobility to a second cell) and may perform AIML operation according to the second configuration, notifying the network of the configuration change.

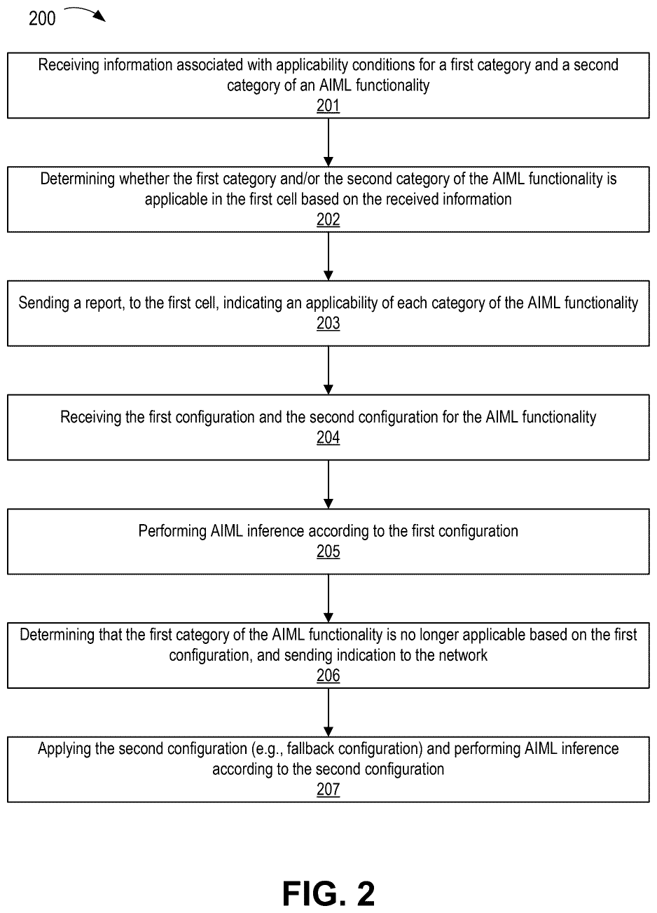

Referring now to FIG. 2, a method 200 for managing AIML functionality based on applicability conditions and configuration switching is illustratively depicted.

At 201, a WTRU may receive, from a first cell (e.g., via system information), information (e.g., network-side additional conditions and/or an associated ID) to determine the applicability of a first and second AIML category for a given AIML functionality. The first and second AIML categories may represent differences in performance, applicability, and/or required WTRU power and/or processing consumption.

At 202, the WTRU may determine whether the first and/or second category of AIML functionality is applicable in the first cell (e.g., based on network-side and/or WTRU-side additional conditions and/or model availability).

At 203, the WTRU may report, to the first cell, the applicability of each category for an AIML functionality, including one or more of the following: the first category of AIML functionality may be applicable in the first cell based on a first configuration (e.g., a configuration to support a detailed AIML model); the second category of AIML functionality may be applicable in the first and/or second cells based on a second configuration (e.g., a configuration to support a general AIML model). Additionally, and/or alternatively, the WTRU may include a list of cells (e.g., via a Physical Cell Identity (PCI) list) where the functionality may be applicable based on the given configuration. Optionally, the WTRU may request to receive multiple configurations (e.g., a first and second configuration) for an AIML functionality, where the first configuration corresponds to a detailed AIML model and the second configuration corresponds to a general AIML model. Additionally, and/or alternatively, the WTRU may indicate a preference regarding which configuration (e.g., the first or second) will be the currently activated configuration and which will be the fallback configuration.

At 204, the WTRU may receive a first and second AIML configuration for the AIML functionality. The WTRU may apply the preferred configuration (e.g., the first configuration) and may store the fallback configuration (e.g., the second configuration). At 205, the WTRU may perform AIML inference according to the first configuration (e.g., corresponding to the detailed AIML model).

At 206, the WTRU may determine that the first category of AIML functionality is no longer applicable based on the first configuration (e.g., the detailed AIML model is no longer applicable). The WTRU may notify the network (e.g., via MAC-CE and/or RRC signaling) that the AIML functionality is no longer applicable based on the first configuration and that the WTRU will apply the fallback configuration (e.g., the second configuration). At 207, the WTRU may apply the stored fallback configuration and may perform AIML inference according to the second configuration (e.g., corresponding to the general AIML model).

Maintaining multiple AIML models with differing levels of generality and/or range of applicability may support increased accuracy when conditions are suitable for applying a detailed model. Additionally, and/or alternatively, maintaining multiple AIML models may support AIML service continuity when detailed model application is not suitable (e.g., due to changing applicability conditions such as mobility) by enabling fallback to a more widely applicable (e.g., general) model.

The examples described herein may support a balance between AIML service continuity, prediction accuracy, and WTRU power and/or processing consumption under changing applicability conditions. These examples may involve one or more of the following example components and/or subcomponents described herein.

The following terminology may be used throughout this document. The definitions provided below may serve as a general description; however, they are not exhaustive and do not preclude other meanings and/or uses.

Artificial intelligence may be broadly defined as behavior exhibited by machines. Such behavior may, for example, mimic cognitive functions to sense, reason, adapt, and/or act. Machine learning may refer to a type of algorithm that may solve a problem based on learning through experience (e.g., data) without being explicitly programmed (e.g., configuring a set of rules). Machine learning may be considered a subset of AI. Different machine learning paradigms may be envisioned based on the nature of data and/or feedback available to the learning algorithm.

For example, a supervised learning approach may involve learning a function that maps an input to an output based on labeled training examples, wherein each training example may be a pair consisting of an input and the corresponding output. Additionally, and/or alternatively, an unsupervised learning approach may involve detecting patterns in data without pre-existing labels. Furthermore, a reinforcement learning approach may involve performing a sequence of actions in an environment to maximize cumulative rewards.

In some examples, machine learning algorithms may be applied using a combination and/or interpolation of the above-mentioned approaches. For example, a semi-supervised learning approach may use a combination of a small amount of labeled data with a large amount of unlabeled data during training. In this regard, semi-supervised learning may fall between unsupervised learning (e.g., with no labeled training data) and supervised learning (e.g., with only labeled training data).

A given AIML model may be trained under certain WTRU-side and/or network-side additional conditions. For example, a WTRU-side condition may include the speed of the WTRU. Additionally, and/or alternatively, network-side additional conditions may relate to network configurations and/or settings that the WTRU may not be aware of but that may impact model performance. For example, a Radio Link Failure (RLF) prediction model may perform differently if it is trained when the network was using a certain antenna pattern, beam pattern, power levels, and/or other network parameters. Additionally, and/or alternatively, aspects related to network load may impact model performance.

Since the WTRU may not need to know all details of the network-side additional conditions (and the network may also not want to expose certain implementation details), the network may conceal these details by signaling one or more associated IDs to the WTRU. For example, during data collection for training a model, tagging may be performed to indicate the network-side additional conditions under which the model is trained. When a WTRU is configured to perform AIML-based RLF prediction, the WTRU may check the consistency between the conditions under which the AIML model was trained and the current conditions (e.g., current WTRU conditions and/or current associated ID(s) signaled by the network indicating current network conditions and/or settings). An associated ID may be specific to a given functionality or may be applicable to multiple functionalities and/or all functionalities.

Life Cycle Management (LCM)-Related terminology may include the term “supported functionality” may refer to AIML functionalities that a WTRU is capable of performing. However, this may not necessarily mean that the AIML functionality can be activated. For example, a WTRU may not have a model trained for the current WTRU and/or network-side additional conditions, may have a model that is not trained, or may not have a model for that functionality at all (e.g., the WTRU may be capable of the AIML functionality from a hardware and/or software perspective but may not have a usable model).

The term “applicable functionality” may refer to functionalities for which the WTRU has at least one model trained for the current WTRU and/or network-side additional conditions (or at least tested to function under those conditions). As such, the functionality may be activated (e.g., the WTRU may use AIML to perform inference instead of, or in addition to, using non-AIML techniques, such as predicting signal levels of serving and/or neighboring cells and/or beams instead of, or in addition to, performing actual measurements). In some cases, the term “applicable functionality” may refer only to functionalities where the WTRU also has the necessary configuration to perform inference, in addition to having a model compatible with the current WTRU and/or network-side additional conditions.

The term “activated functionality” may refer to functionalities for which the WTRU is already using an AIML model for inference (e.g., using an AIML model to predict signal levels of beams and/or cells).

The term “configured functionality” may refer to functionalities for which the WTRU has been provided with a configuration (at least to determine functionality applicability). Some configured functionalities may be applicable, while others may not be applicable. Additionally, some applicable functionalities may be activated, while others may not be activated.

The following terminology may be used interchangeably throughout this document. The terms AI/ML and AIML may be used interchangeably. The terms data, measurements, report, and results may be used interchangeably. The terms indication, information, and message may be used interchangeably. The terms current cell, serving cell, and source cell may be used interchangeably. The terms target cell, candidate cell, and neighbor cell may be used interchangeably. The terms handover and cell switching may be used interchangeably. The terms functionality and procedure may be used interchangeably. The terms execute, apply, and perform may be used interchangeably. The terms send recovery message and initiate recovery may be used interchangeably to indicate the WTRU sending the re-establishment request or the handover complete message. The terms legacy and non-AIML may be used interchangeably. The terms inactive, inactivated, non-active, non-activated, dis-active, and dis-activated may be used interchangeably. The term a target cell that enables a functionality may have the same meaning as a functionality is applicable at the target cell.

The following generalizations may be considered for the examples described within this document. A WTRU may be capable of collecting data for training an AIML model without necessarily being capable of AIML-based operations. The data collected may be used for training a network-sided model, a WTRU-sided model, or both WTRU-side and network-side components of a two-sided model (e.g., a CSI compression model where an encoder model is implemented at the WTRU and a corresponding decoder model is implemented on the network side).

The examples described herein may be agnostic to the type of AIML model and/or technique used by the WTRU (e.g., the algorithm used, the mechanism such as a neural network, the type of neural network, depth, and/or parameters/weights of the network), the origin of the model (e.g., WTRU vendor, operator, network vendor), and/or how and where the model training is performed (e.g., the input data used for training, the location of training, whether the training is performed offline or online). However, it may be assumed that the model is trained based on historical observations of one or more WTRUs'actual measurements in different WTRU and/or network conditions (e.g., during specific times of the day, on certain days of the week, at different locations, under different WTRU mobility patterns and/or speeds, under different network conditions visible to the WTRU such as frequency and/or bandwidth, and/or under different network configurations, which may be visible to the WTRU only as a network configuration index provided by the network during training or data collection for training).

During normal operations, it may be assumed that an AIML function must be applicable before it can be activated. However, in some cases, an AIML function may be activated but not applicable. For example, a WTRU may move from one cell to another where the functionality is no longer applicable due to a change in network-side additional conditions in the new cell. If the WTRU is not configured to autonomously activate and/or deactivate functionalities, there may be a transition period where the functionality remains activated despite being inapplicable (e.g., during the time the WTRU informs the network that the functionality is not applicable and the network subsequently deactivates the functionality for AIML operation).

The example descriptions below may be applicable to both model-ID-based and functionality-based LCM. Specifically, the examples may relate to how the WTRU determines whether it has a model applicable for the indicated associated ID(s). For example, in the case of functionality-based LCM, the WTRU may be configured and/or requested to determine whether a given functionality is valid and/or applicable. In such cases, the WTRU may evaluate all models available for a given functionality and may consider the functionality applicable if at least one model is applicable. In another example, in the case of model-ID-based LCM, the WTRU may be configured and/or requested by the network to determine whether a particular model is applicable.

A WTRU may support multiple AIML models for a given functionality (e.g., models with different prediction time horizons, prediction confidence levels, processing requirements, and/or models trained for operation under different frequencies, cells, locations, and/or times of day). A given AIML model for a certain functionality may operate in different modes (e.g., with varying levels of prediction confidence at different prediction time horizons, at different locations, frequencies, WTRU mobility patterns, and/or speeds).

AIML models may be available at the WTRU in a pre-trained state, or the WTRU may be provided with an untrained AIML model and may perform the training independently. Additionally, and/or alternatively, an AIML model may be available at the WTRU already trained, and the WTRU may be enabled and/or configured to perform further training (e.g., for different conditions such as frequencies, cells, locations, and/or times of day; for the same conditions as the initial training but to increase the level of confidence and/or the prediction time horizon; and/or for different WTRU speeds). Furthermore, an AIML model may be available at the WTRU but may not be trained at all or may only be trained for certain WTRU and/or network conditions. In such cases, the WTRU may be configured to train the model for conditions where it has not yet been trained.

A WTRU may be provided with one or more configurations to support AIML service continuity, including fallback to an alternative AIML model and/or legacy (e.g., non-AIML) operation. Examples may include configurations to support AIML operation, applicability reporting for an AIML functionality with multiple AIML models, and/or the request and/or reception of multiple AIML configurations for a single AIML functionality (e.g., associated with different AIML models). Additionally, and/or alternatively, configurations may support AIML configuration switching (e.g., triggering, configuration application, and/or WTRU-network coordination) and/or fallback to legacy (e.g., non-AIML) operation.

AIML fallback may be initiated if supported by both the WTRU and the network. A WTRU may indicate capability for one or more aspects of AIML fallback (e.g., prior to initiating the procedure and/or receiving associated configurations). Additionally, and/or alternatively, a network may indicate support (e.g., per cell) for one or more aspects of AIML fallback. A WTRU may initiate a procedure and/or expect configuration only with one or more cells that support the procedure. The examples described herein may support the indication of WTRU capability, network support, and/or the reception of one or more configurations for AIML fallback.

In some examples, a WTRU capability may be utilized to enable fallback to an alternative AIML model (e.g., to support AIML service continuity) and/or legacy non-AIML operation (e.g., if no alternative model is applicable). The capability may relate to all aspects of AIML fallback or may be specific to individual aspects of the fallback procedure. Support for AIML fallback may be reported by the WTRU and/or indicated by the network (e.g., on a cell-specific basis).

A WTRU may indicate capability and/or support for one or more aspects of AIML fallback. In one example, the WTRU may indicate a single capability to represent support for all aspects of AIML fallback. Alternatively, the WTRU may report support for each aspect of AIML fallback individually. For example, the WTRU may indicate support for one or more of the following: reception of different categories of applicability information (e.g., high-level and detailed), applicability reporting for different AIML categories for a given functionality, maintaining multiple configurations for a given AIML functionality (e.g., to support different AIML models corresponding to a different category), application of different AIML configurations for a given functionality (e.g., based on a change in applicability, performance, and/or conditions), and/or WTRU autonomous model switching.

A WTRU may report the capability of one or more aspects of AIML fallback, for example, via the WTRU capability transfer procedure. Additionally, and/or alternatively, the WTRU may indicate capability and/or support using one or more of the following methods: random access (e.g., using one or more dedicated resources, random access preamble partitioning, a set of reserved preambles or random access occasions, and/or Radio Network Temporary Identifiers (RNTIs)), upon RRC connection establishment and/or resumption (e.g., via Msg3 and/or Msg5), upon request from the network (e.g., upon reception of a capability enquiry message), and/or via WTRU assistance information.

In some examples, the capability to support, perform, execute, and/or initiate one or more aspects of AIML fallback may be linked to one or more other configurations. For example, the network may assume that a WTRU is capable of one or more aspects of AIML fallback based on the activation, state, and/or configuration of one or more of the following: the configuration of an AIML model and/or functionality, the activation of an AIML model and/or functionality, and/or the availability of an AIML model and/or functionality.

In another example, the capability and/or support for initiating one or more aspects of AIML fallback may be reliant on one or more characteristics of the WTRU. For example, AIML fallback initiation may depend on one or more of the following: the performance of an AIML model and/or functionality, WTRU speed, remaining WTRU power, WTRU processing ability, and/or WTRU location (e.g., within a certain set of cells, using one of a set of specific beams, and/or based on GPS location). Additionally, and/or alternatively, AIML fallback initiation may be based on whether a particular type of service is in use (e.g., related to one or more specific network slices and/or Quality of Service (QoS) Class Identifiers (QCIs)).

If a WTRU is configured for AIML fallback and an associated configuration is not present and/or active and/or the WTRU characteristics are not suitable, the procedure may be temporarily disabled (e.g., the WTRU may not initiate the procedure) or inactive. The WTRU may indicate to the network, subject to configuration, that AIML fallback is temporarily inactive (e.g., via a MAC CE, Uplink Control Information (UCI), and/or RRC signaling). Additionally, in some examples, the WTRU may report the reason why the procedure is inactive (e.g., a joint configuration is disabled and/or the WTRU characteristics are not suitable).

In some examples, the network may indicate support for AIML fallback. Support for AIML fallback may be specified per cell, per Public Land Mobile Network (PLMN), per frequency, per Tracking Area (TA), and/or per Radio Access Network (RAN) Notification Area (RNA). The indication may be provided, for example, as a flag and/or bit in system information to indicate support for AIML fallback. Additionally, and/or alternatively, the network may indicate support for a specific aspect of the procedure (e.g., a cell may support delta configuration but not a unified reference configuration). In another example, the network may indicate, within system information and/or via RRC configuration, a list of one or more cells that support AIML fallback.

In some examples, a WTRU may initiate AIML fallback, or one or more aspects of AIML fallback, only if the network supports the procedure. For example, the WTRU may resume AIML operation upon returning to RRC connected mode only if the cell has indicated support for AIML fallback.

In some examples, a WTRU may receive one or more configurations to support AIML operation. Such configurations may be provided per functionality and/or per model (e.g., a different configuration or set of configurations may be provided for a detailed model versus a general model). Examples may include configurations for model training, inference, performance monitoring, data collection, and/or applicability reporting.

In some examples, a WTRU may receive one or more configurations for AIML model training. Examples of configurations for model training may include criteria for updating a model, criteria for determining when a model is done training, criteria for downloading a new model, criteria for re-training a model, and/or configurations to train a model (e.g., training duration and/or number of iterations).

In some examples, a WTRU may receive one or more configurations for AIML inference. Examples of configurations for inference may include models in which to perform inference, information characteristics needed for input, and/or network-side additional conditions and/or associated ID(s) on which the model has been trained.

In some examples, a WTRU may receive one or more configurations for AIML performance monitoring. Examples of configurations for performance monitoring may include when to perform performance monitoring (e.g., periodicity and/or duration), criteria for performance monitoring (e.g., thresholds), and/or criteria to report performance monitoring results (e.g., when performance has dropped below a threshold).

In some examples, a WTRU may receive one or more configurations for AIML data collection. Examples of configurations for data collection may include measurement configurations, associated ID(s), network-side additional conditions, limits on the amount of data collected, types of data and/or events to collect, triggers to report collected data, and/or formats to report collected data.

In some examples, a WTRU may receive one or more configurations for AIML applicability reporting. Examples of configurations for applicability reporting may include whether to proactively or reactively report applicability, whether the WTRU can report non-applicability, whether the WTRU can transmit an update during a connected state regarding the applicability of a model, and/or triggering conditions to report applicability (e.g., when a functionality becomes non-applicable).

In some examples, a WTRU may receive one or more configurations to support the request and/or reception of an AIML fallback configuration. This may include applicability determination and reporting for an AIML functionality supported by multiple models and/or the request and reception of a fallback AIML configuration.

In some examples, a WTRU may receive one or more configurations for applicability reporting of an AIML functionality supported by multiple AIML models. Examples of such configurations may include an indication (e.g., a flag and/or bit) to enable or disable multiple types of applicability information (e.g., high-level versus detailed), an indication (e.g., a flag and/or bit) to enable or disable applicability reporting for multiple AIML models for a given functionality, and/or an indication (e.g., a flag and/or bit) to enable or disable the inclusion of assistance information (e.g., expected performance and/or power and/or processing requirements) within an applicability report.

In some examples, a WTRU may receive one or more configurations for the request and reception of a fallback AIML configuration. The configuration may include an indication (e.g., a flag and/or bit) to enable and/or disable support for requesting multiple configurations for a given AIML functionality. The configuration may include an indication (e.g., a flag and/or bit) to enable and/or disable support for indicating a preferred configuration for a given AIML functionality. The configuration may include an indication (e.g., a flag and/or bit) to enable and/or disable support for updating a preferred configuration for a given AIML functionality. The configuration may include an indication of which configuration is a default configuration (e.g., if no preferred configuration is supported and/or indicated).

In some examples, a WTRU may receive one or more configurations to support the application and operation of an AIML fallback configuration. The configuration may include parameters for triggering and switching conditions, the necessity of WTRU-network coordination, and fallback to non-AIML operation.

In some examples, a WTRU may receive one or more configurations for triggering and switching to a fallback AIML configuration. The configuration may include an indication (e.g., a flag and/or bit) to enable and/or disable support for fallback based on a change in applicability conditions. The configuration may include an indication (e.g., a flag and/or bit) to enable and/or disable support for fallback based on a change in performance (e.g., a decrease in performance by the currently applied configuration and/or an increase in performance provided by a stored configuration). The configuration may include performance monitoring criteria to support fallback in case of decreased performance of the current AIML configuration and/or improved performance from a stored configuration (e.g., thresholds). The configuration may include conditions to switch AIML configurations (e.g., WTRU speed thresholds and/or upon mobility). The configuration may include an indication of whether to store or release a former AIML configuration upon switching (e.g., may also be associated with specific events and/or causes of switching).

In some examples, a WTRU may receive one or more configurations for WTRU-network coordination on AIML fallback. The configuration may include an indication (e.g., a flag and/or bit) to enable and/or disable support for WTRU-autonomous switching between AIML configurations for a given functionality. The configuration may include an indication (e.g., a flag and/or bit) to enable and/or disable support for additional assistance information regarding why the WTRU is switching and/or requesting a switch of an AIML configuration.

In some examples, a WTRU may receive one or more configurations for fallback to non-AIML operation. The configuration may include conditions (e.g., performance thresholds) to fallback to legacy (e.g., non-AIML) operation. The configuration may include a duration to prohibit switching between AIML configurations. Methods to reacquire, adapt, and/or release configurations for AIML fallback may be utilized to ensure that a WTRU continues to maintain related AIML configuration(s) and/or AIML operation.

A WTRU may be provided with one or more configurations for AIML fallback upon establishment and/or resumption of an RRC connection (e.g., within an RRC Setup and/or Resume message), upon handover to another cell (e.g., within a handover command and/or RRC reconfiguration message with reconfiguration with synchronization), or at any time during an active RRC connection (e.g., within an RRC reconfiguration message without reconfiguration with synchronization). In some examples, configurations for multi-cell LCM may be indicated, configured, and/or provided via one or more signaling methods, including SIB (e.g., a new SI block and/or within another existing SIB), NAS, MAC CE, DCI, RACH (e.g., MSG2, MSG4, and/or MSGB), RRC, and/or PDCCH/PUSCH.

A WTRU may receive different information and/or components of an AIML fallback configuration via different signaling methods. For example, a WTRU may receive some dedicated configuration aspects via RRC signaling (e.g., measurement resource configuration(s) for one or more AIML models) and other configurations and/or information via system information (e.g., an indication of which cell(s) support AIML fallback). If a WTRU is provided with a dedicated configuration and/or indication related to AIML fallback, the WTRU may override other common configuration information (e.g., received via broadcast signaling) and/or may combine the dedicated configuration with one or more pieces of common configuration information. In another example, the WTRU may use the most recently received information in the configuration, regardless of the signaling method.

A WTRU may receive one or more alternative configurations using one signaling method (e.g., via system information and/or dedicated RRC signaling). Using another type of signaling (e.g., via dedicated RRC signaling and/or MAC CE), the network may select or indicate which of the one or more alternative configurations to apply.

A WTRU may receive a configuration based on a NW decision (e.g., upon release to Radio Resource Control (RRC) IDLE or RRC INACTIVE) if the WTRU may indicate it may be capable of AIML fallback. Additionally, and/or alternatively, the WTRU may request to be configured for AIML fallback, request configuration(s) for AIML fallback, update existing configuration(s) for AIML fallback, and/or apply different configuration(s) for AIML fallback.

The WTRU may release related configurations for AIML fallback (e.g., all or one or more parts of a configuration) under one or more of the following circumstances, including when the current serving cell may not support AIML fallback and/or when the WTRU may not have an active, available, configured, or supported AI/ML functionality/model to require and/or perform AIML fallback.

Operation of an AIML model may utilize configuration (e.g., measurement resources) to support model input and inference, with different AIML models possibly requiring different configuration(s). In functionality-based Lifecycle Management (LCM), a WTRU may receive a configuration based on applicability reporting, and upon non-applicability, the WTRU may receive an updated configuration. Simultaneous configuration for multiple AIML models may require modification to current LCM procedures (e.g., capability, applicability, and configuration) to support indicating the necessary configuration(s) to support different models within a functionality (e.g., general vs. detailed) as well as the management of multiple AIML-related configuration(s).

Examples described herein may support enhancement to LCM procedures to support the request, reception, management, and applicability reporting for multiple AIML configurations for a single functionality. Such examples may allow the pre-configuration and storage of configuration(s) to support AIML fallback model operation, supporting service continuity of AIML operation.

A WTRU may have a single AIML model to support an AIML functionality. In such cases, the applicability of an AIML functionality may correspond to the applicability conditions of the AIML model (e.g., the conditions in which the model was trained). In another example, the WTRU may have multiple models that support a given AIML functionality. In such scenarios, the applicability of a functionality may depend upon the applicability of the model used. For example, if the WTRU uses a detailed model with a narrow applicability range, the applicability of the functionality may be correspondingly narrow. Alternatively, if the WTRU uses a general model with a wide applicability range, the applicability of the functionality may be correspondingly wide.

Notifying the network of a given functionality's different applicability (e.g., based on the model used for the functionality) may support the configuration and selection of the AIML model best suited for the current conditions. Examples described herein may support the applicability determination and reporting for a functionality supported by multiple AIML models.

In some examples, the WTRU may evaluate the applicability of a functionality supported by multiple AIML models. Each model may be trained with a different data set and may therefore possess a different sensitivity to applicability conditions. For example, an AIML model may be trained on a wide data set and may be considered applicable under a wide range of conditions or may not be very sensitive to changes in applicability conditions. Such models may be described as “general models,” wherein the use of a model may generalize well to a broad set of applicability conditions. In another example, an AIML model may be trained under a narrow set of applicability conditions or may be sensitive to variations in applicability conditions. Such models may be described as “detailed models.”

The information utilized to evaluate the applicability of a general versus detailed AIML model may vary, and in one example, the WTRU may be provided with different set(s) of applicability information to evaluate the different categories and/or tiers of AIML applicability. For example, a first set of applicability information may correspond to a set of high-level parameters (e.g., number of TRPs) associated with the cell and may be used to evaluate whether a more general or widely trained model may be applicable for a given cell. A second set may correspond to a set of detailed parameters (e.g., the number of panels and polarization of each antenna) associated with a cell and may be used to evaluate the applicability of a detailed set of models. Although the second set of detailed parameters may not necessarily impact the performance of a more general model, such parameters may have a large impact on the applicability of the more detailed model.

A WTRU may operate using one or more AIML model categories (e.g., a first AIML model category and/or a second AIML model category). Each AIML model category may correspond to a trained AIML model (e.g., differently trained model) optimized for different network conditions. The first AIML model category may be associated with an AIML model trained using a dataset that represents a defined and constrained set of network conditions. These conditions may include a fixed number of transmission-reception points (TRPs), predefined antenna configurations, and/or a low-mobility environment (e.g., an indoor enterprise network and/or a small-cell deployment with limited user movement). The second AIML model category may be associated with an AIML model trained using a dataset that includes a broader set of network conditions, including a variable number of TRPs, dynamically adjusted antenna configurations, and mobility across multiple serving and neighboring cells, such as those encountered in macrocellular networks or high-mobility scenarios (e.g., vehicular movement and/or handovers between different base stations).

A predefined number of TRPs may be used as an applicability condition for selecting an AIML model category. In some scenarios, the predefined number of TRPs may be fixed, such as in a network deployment where the number and locations of TRPs may remain constant, including small-cell environments, enterprise networks, or private industrial deployments. In such cases, a first AIML model category may be trained using data corresponding to the fixed TRP configuration, allowing the model to optimize inference based on consistent network parameters. In some examples, the predefined number of TRPs may vary dynamically, such as in macrocellular deployments, heterogeneous networks, or mobile user scenarios where TRP availability is influenced by factors such as mobility, network load balancing, and/or dynamic beam adjustments. In such conditions, a second AIML model category may be used, where the AIML model may be trained to accommodate variable TRP availability and may adapt to network-side reconfigurations. This may provide for accurate inference even when the network environment is dynamically changing, ensuring continuous AIML-based optimization across different deployment scenarios.

The first AIML model category may be configured for inference in network conditions where the network topology remains largely stable. In such conditions, the number of TRPs available to the WTRU may remain consistent. Antenna configurations (e.g., tilt, polarization, and/or beamforming) may be predefined and may not dynamically change, and the WTRU may be either stationary or moving at low speeds (e.g., corresponding to a pedestrian walking speed such as 3 km/hr) within a confined coverage area (e.g., an office building, stadium, and/or industrial IoT deployment). In this case, the AIML model associated with the first AIML model category may be trained with a dataset focused on these conditions, enabling high-precision inference.

By limiting the scope of the dataset, the first AIML model category may provide improved prediction accuracy under known conditions. However, such a model may be sensitive to variations that fall outside its trained parameters, such as mobility events, dynamic beamforming adjustments, and/or inter-cell transitions. Accordingly, when the WTRU detects that the first AIML model category is no longer applicable based on, for example, changes in network conditions, the WTRU may initiate a transition to the second AIML model category.

The second AIML model category may be configured for inference in network conditions where network topology and radio characteristics fluctuate. In such conditions, the number of TRPs available to the WTRU may vary due to, for example, changes in signal propagation, interference, or mobility. Additionally, and/or alternatively, the network may dynamically adjust antenna parameters, including tilt, polarization, and/or beamforming settings, to optimize performance in response to changing user distributions and load conditions. The WTRU operating in the second AIML model category may also experience mobility across multiple serving and neighboring cells, including, for example, inter-cell handovers, transitions between macro and small cells, and/or movement within a heterogeneous network environment (e.g., 5G NR deployment with multiple gNBs).

To accommodate these variations, the AIML model associated with the second AIML model category may be trained using a dataset encompassing a wider range of network conditions than the first AIML model. This broader dataset allows the model to generalize inference predictions across multiple scenarios, ensuring continued applicability even when the network environment changes. While the second AIML model category may provide inference results with a slightly lower precision per condition relative to the first AIML model category, its ability to function reliably across diverse and dynamic conditions ensures that AIML-based optimizations can continue without disruption.

A WTRU may receive configuration information corresponding to both the first AIML model category and the second AIML model category. Such configurations may include details regarding applicable network conditions, model selection criteria, and/or transition thresholds. The WTRU may initially apply the first AIML model category when operating within its defined applicability conditions. If the WTRU determines that these conditions no longer hold (e.g., due to increased mobility, changing TRP availability, and/or dynamic beam adjustments), the WTRU may apply the second AIML model category and perform inference using the associated AIML model.

Additionally, and/or alternatively, the WTRU may report the applicability of each AIML model category to the network, enabling the network to optimize resource allocation and model updates. The WTRU may also store fallback configurations for each AIML model category to ensure rapid transitions between models without requiring real-time reconfiguration from the network.

The data set used to train a model may not only impact the sensitivity of an Artificial Intelligence and Machine Learning (AIML) model but also the inference capabilities and performance of the AIML functionality. For example, a general model may provide satisfactory inference results over a broad range of applicability conditions, whereas a detailed model may provide better inference results over a narrower range of applicability conditions. Similarly, a detailed model may allow the prediction or inference of a greater range of outputs, whereas a general model may only support a subset of such predictions. For example, a detailed model may allow the prediction of L1 and L3 Reference Signal Received Power (RSRP), whereas a general model may only support the prediction of L3 RSRP. Other examples may include differences in one or more of the following: differences in prediction accuracy/performance (e.g., a detailed model may yield a closer prediction or margin of error to the ground truth than a general model), differences in prediction time horizon (e.g., a detailed model may support prediction longer into the future than a general model), and/or differences in prediction output (e.g., a detailed model may support additional prediction capabilities than a general model, such as 3D position vs. 2D position and/or Channel State Information (CSI) vs. Synchronization Signal Block (SSB)).

In examples, for a functionality supported by multiple AIML models, depending on the model chosen, the functionality may support a different range of applicability, utilize different information to determine the applicability, support different performance, and/or support additional prediction output. For example, a first model (e.g., a general model) may support a wide range of applicability and only utilize a subset of applicability information to determine applicability. The first model may offer moderate performance and a subset of inference capabilities. A second model (e.g., a detailed model) may support a limited range of applicability determined by additional applicability information and may offer improved performance and an increased range of possible inference output.

A Wireless Transmitting/Receiving Unit (WTRU) may therefore receive different categories of applicability information. A first category (or alternatively tier) may represent a minimum set of high-level applicability conditions (e.g., number of TRPs and/or number of antennas). Such information may be used, for example, to evaluate a first category of AIML models (e.g., those models which may be more general and/or applicable to a broader range of applicability conditions). In some scenarios, such information may additionally be consistent across multiple cells or an area. In this case, the network may provide a list of cells, areas, PLMN, TAC, RNAs and/or other relevant parameters where the WTRU may assume that the first category of applicability conditions can be assumed consistent. The WTRU may also assume that a model which is applicable in one cell based on such applicability conditions may also be applicable in another cell which shares these applicability conditions. A second category or tier of applicability conditions may represent a more detailed set of applicability conditions (e.g., the antenna tilt within a set of degrees and/or the polarization of an antenna), which may be used, for example, to evaluate a second category of AIML models (e.g., those models which may be more detailed and/or apply to a small range of applicability conditions). In some scenarios, such information may be considered as only valid within a given cell, beam, area or time-period. The WTRU may assume that outside of the more limited conditions associated with such information, the applicability information may no longer be valid.

In one example, the WTRU may receive a first and second set of applicability information which the WTRU may use to evaluate a first set (e.g., general) and second set (e.g., detailed) models. In one example, the WTRU may be provided with different categories of applicability conditions via different methods, for example, the first set of applicability information may be provided via system information or in a group common manner, whereas the second set of applicability information may be provided via Radio Resource Control/MAC Control Element (RRC/MAC CE) or in a WTRU specific manner. Providing such information via different signaling methods may avoid additional signaling overhead of providing detailed information which may not be needed to evaluate all models or supported by all WTRUs. In another example, the WTRU may only receive the second set of applicability information via a WTRU request.

In some examples, upon reception of a first and second set of applicability information, a Wireless Transmitting/Receiving Unit (WTRU) may evaluate and report the applicability of a first and second category of Artificial Intelligence and Machine Learning (AIML) models for a given AIML functionality. In one example, the WTRU may receive a first and second set of applicability information and may evaluate the applicability of all models for functionalities A and B. Based on the first and second set of applicability information, the WTRU may determine that functionality A supports both a first and second category of AIML models (e.g., functionality A supports both general and detailed high-accuracy models), whereas functionality B may support only a first category of AIML models (e.g., a general model).

Upon the determination of the applicability of different categories of applicability for each AIML functionality, the WTRU may report the applicability of each category for each AIML model. For example, the WTRU may report based on the above information that functionality A may be applicable for both a first and second category of AIML models, whereas functionality B may be applicable for only a first category of AIML models.

The WTRU may report additional information along with the applicability of each AIML category. For example, each category may additionally include information related to one or more of the following aspects. Aspects may include the expected performance of each model category (e.g., the inference latency and/or proximity to ground truth), the output capability of each category (e.g., for a model used for mobility, a first category of AIML models may support L3 RSRP prediction, whereas a second category of models may support both L1 and L3 RSRP prediction), and/or the WTRU power and/or processing requirements associated with each category of AIML model.

Whether the WTRU includes such additional information may be based on, for example, the network enabling or disabling assistance information, whether the WTRU may support multiple categories of AIML performance/applicability for a given functionality, whether the network can provide or support a second set of detailed applicability information for a given cell, and/or whether the WTRU may support multiple models for a given AIML functionality.

The WTRU may have a single AIML model to support an AIML functionality. In such cases, the WTRU may only utilize a single configuration to support the AIML functionality. Alternatively, the WTRU may have multiple models to support a given functionality (e.g., associated with a first and second category), each possibly utilizing a different configuration to support the model operation (e.g., a different set of measurement resources for model input). To support the seamless switching of AIML models for a given functionality (e.g., in the event of non-applicability of an AIML model or poor performance), the WTRU may receive multiple configurations simultaneously. Such examples may allow the WTRU to store and switch between configurations without the additional delay of non-applicability and reconfiguration signaling, supporting improved AIML service continuity for a given functionality.

The WTRU may require a different configuration and/or set of configurations to support AIML operation according to a different model and/or AIML category for a given functionality. Such configurations may include, for example, one or more parameters described within Section 4.2. For a functionality with both a first and second category of AIML models applicable, the WTRU may request multiple (i.e., more than one) configurations for a given functionality (e.g., to support each AIML category). By requesting and providing multiple configurations in advance, the network may support AIML service continuity at the WTRU. For example, as previously described, a second category of AIML may be preferred (e.g., when applicable) as it may enable improved inference accuracy and performance; however, based on more narrow applicability, it may not always be available. If the WTRU has multiple configurations available, in the event that AIML operation may no longer be suitable based on a given configuration, the WTRU may switch to an alternative configuration which supports a more general and/or widely applicable AIML model.

The WTRU may indicate a preferred configuration among the requested configurations. It may be assumed, for example, that when both AIML categories are applicable, the WTRU may apply the configuration associated with the preferred configuration, and the WTRU may store and/or maintain the alternative configuration (e.g., when the preferred configuration may no longer be suitable due to performance and/or applicability issues). In case the WTRU does not indicate a preferred configuration, the WTRU may indicate which configuration may be initially applied (e.g., within the request for multiple configurations) or the network may assign a default configuration. In another example, the WTRU/network may assume that the preferred configuration may be according to which performs better based on a given metric (e.g., performance, inference accuracy, inference latency, power consumption, applicability and/or similar). The WTRU may update the preference of the configuration, for example, based on a change of WTRU state or circumstances (e.g., the WTRU has become mobile and may prefer a more general model which may better suit the AIML service continuity).

To receive and update an AIML configuration, current procedures may utilize capability signaling, applicability reporting, AIML configuration, non-applicability reporting, and reconfiguration. Switching an AIML model for a given functionality according to current procedures may therefore introduce additional Lifecycle Management (LCM) signaling overhead and AIML service disruption (e.g., while the WTRU is receiving an updated configuration). Alternatively, the reception and maintenance of multiple configuration(s) (e.g., to support more than one AIML model per functionality) may allow the WTRU to rapidly switch models for a given AIML functionality.

Since each configuration supports a model with different characteristics (e.g., inference accuracy, generality to applicability conditions, WTRU power/processing requirements and/or similar), a WTRU must balance competing requirements for optimal AI performance and service continuity. Examples described herein may support the switching and application of a secondary (e.g., stored) AIML configuration, supporting rapid AIML reconfiguration to enable operation of a model which is suited to the WTRU's current needs and/or applicability conditions, while maintaining AIML service continuity and coordination with the network.

In some examples, the WTRU may switch between one or more AIML models and corresponding configurations for a given functionality, for example, to support service continuity or a change in WTRU power and/or processing requirements. In some examples, how the WTRU switches between AIML models and corresponding configurations may be left to WTRU implementation. Alternatively, there may be specific conditions in which the WTRU may switch AIML models, such as based on model applicability or network request.

The WTRU may determine that an AIML functionality is no longer applicable based on a first configuration, such as one corresponding to a detailed AIML operation. For example, upon reception of new or updated applicability conditions, the WTRU may re-evaluate the applicability of all models and categories of models for a given AIML functionality. If it is found that the current configuration does not support the new or updated applicability conditions, the WTRU may then evaluate whether an alternative category and/or model of functionality is applicable to the given applicability conditions. If one is available, such as a general model, the WTRU may apply the revised configuration.

The WTRU may determine that an AIML functionality remains applicable; however, the performance of the AIML model may not be adequate, for example, if the inference latency has exceeded a threshold or the delta between output and ground truth has exceeded a threshold. In such scenarios, the WTRU may apply an alternative configuration which supports an AIML model that may improve the performance, for example, above a threshold. In another example, the WTRU may have another configuration that can support a model with improved performance, even though the performance of the current configuration may still be determined to be adequate. The WTRU may switch AIML configurations to the model that may offer the determined best performance.

The WTRU may fallback to another configuration based on the satisfaction of one or more conditions. For example, upon mobility, the applicability information of a given model may be shared or consistent among several cells. The WTRU may determine whether the applicability information is shared by the new cell and then switch to a corresponding configuration that supports the applicable conditions. The WTRU may revert to a general or default configuration or model upon performing mobility to a new cell to increase the chance that the functionality may perform in the new cell. When Radio Link Failure (RLF) is detected, the WTRU may switch from performing connected mode measurements to performing a cell selection. If out of sync is detected, at least the serving cell measurement may no longer be suitable, so in these cases, the model type or configuration may need to switch. Changes in WTRU speed or other environmental factors, such as power or memory shortages or overheating, may also trigger a fallback to another configuration. Changes in network side conditions, including the two-sided model case where the network side may have fallen back on its side, may permit the WTRU side to use the first model.

In some examples, upon the detection that AIML operation may no longer be suitable according to a configuration and a second configuration may be available, the EU may apply the second configuration. Application of the second configuration may be conditional on the applicability and/or performance of the second configuration, or the WTRU may apply the configuration temporarily and determine whether it may continue accordingly.

Upon application of the second configuration, the WTRU may maintain the first configuration and/or release the first configuration. The WTRU may perform different handling of the first configuration depending on the configuration or the event which caused the switch to the second configuration. If the switch in configuration was due to performance or a change in applicability conditions, the WTRU may maintain the configuration in case the applicability conditions or performance may improve. If the switch was due to mobility, the WTRU may release the configuration since the WTRU may have a degree of confidence that it may not return to the old cell, and the former configuration may not be valid within the new cell. The differentiated handling of former configurations based on the event which causes the switch may avoid additional signaling overhead by having to re-configure the same configuration and avoid the WTRU maintaining old configurations which may not become useful again at some point in the future.

In functionality-based AIML, the details of AIML model operation may not be known to the network. However, in the case of multiple stored configurations being maintained for a single functionality, additional coordination may be needed between the WTRU and network, for example, when the WTRU applies a different configuration during AIML model switching. Such coordination may be necessary to align the WTRU and network on the configuration being used by the WTRU, for example, to ensure that the network continues to transmit the reference signals used by the WTRU for model input.

In some examples, the WTRU may notify the network (e.g., via MAC Control Element or Radio Resource Control signaling) that an AIML functionality may no longer be applicable based on a first configuration. Notification to the network may include that AIML operation may no longer be applicable according to the current configuration, identification information (e.g., an index value) to identify the current configuration which is no longer applicable, notification that one or more alternative applicable configurations are available at the WTRU which may support continued AIML operation for the functionality, a preferred alternative configuration, notification that no other configuration is available at the WTRU, and/or the reason(s) the original configuration is no longer applicable (e.g., change in applicability conditions, performance has fallen below a threshold, and/or better model performance is available with another model).

In some examples, the WTRU notification may act as a request to the network to apply a second configuration, such as if the WTRU indicates that a functionality may continue according to a second configuration. Upon transmission of the notification, the network may approve the switch to the secondary configuration, for example, via an ACK or explicit confirmation. Upon reception of the ACK or confirmation, the WTRU may apply the second configuration and continue AIML operation for the AIML functionality. In another example, the WTRU may apply the fallback configuration, such as the second configuration, without prior approval from the network and may notify the network after it has applied the new configuration. If this configuration is no longer suitable for network operation, the network may respond with an indication that the WTRU should revert to the original configuration and/or fallback to legacy (i.e., non-AIML) operation.

The WTRU may change the configuration based on an alternative configuration becoming available that allows better performance and/or additional inference capability compared to the current model. In this case, the WTRU may also inform the network that a better model is currently available and that the WTRU would like to switch to a secondary configuration.

The WTRU may include additional information related to the new configuration operation, including expected performance and inference capability (e.g., inference latency and/or possible output).

In some examples, despite maintaining multiple configurations for a given AIML functionality, the WTRU may terminate AIML operation and fallback to legacy (e.g., non-AIML) operations. Possible reasons or triggers for falling back to legacy operation may include the absence of an alternative configuration for a currently applicable model, the absence of an alternative configuration for a model with sufficient performance according to performance monitoring criteria, explicit network indication, prohibition of fallback to an alternative AIML condition, and/or performance of all AIML models or functionalities falling below a threshold.

Upon determination that the WTRU may fallback to legacy non-AIML operation, the WTRU may suspend AIML-related configuration(s), release AIML-related configuration(s), flush data collection buffers, and/or cancel AIML-related transmissions/receptions (e.g., inference results, collected data reports, model transfer and/or similar). The WTRU may perform the above actions for all AIML functionalities and/or only the AIML functionality in which the fallback applies. The WTRU may notify the network of fallback to legacy operation. Fallback to legacy (e.g., non-AIML operation) may be important to support when one or more of the above criteria occurs to avoid network and/or WTRU decisions (e.g., mobility) being based on AIML inference which may not be reliable (e.g., due to poor applicability or performance).

The WTRU may be prohibited from using a fallback AIML model. Such prohibition may be, for example, semi-static or may be subject to a time period. The prohibit timer period may be maintained by a timer, wherein upon application of a new configuration, the WTRU may start the timer. While the prohibit timer is running, the WTRU may not apply a second and/or fallback configuration. The EU may maintain a single prohibit timer for all AIML functionalities or may maintain prohibit timers individually for each AIML functionality. Prohibit conditions may be configured to ensure that the WTRU does not continuously switch AIML models, which could lead to dynamic variation in AIML performance and may cause unreliability in the inference results and/or prediction.

The WTRU may report the applicability of an AIML functionality and configuration information required for a first and second category of AIML operation. The WTRU may receive a first configuration to support AIML operation according to a first category (e.g., a configuration to support a detailed AIML model) and a second configuration to support AIML operation according to a second category (e.g., configuration information to support a general AIML model). The WTRU may perform AIML operation according to the first configuration and store the second configuration (e.g., as a fallback). The WTRU may determine it may no longer perform AIML operation according to the first configuration (e.g., as a function of mobility to the second cell) and may perform AIML operation according to a second configuration, and may notify the network of the change of configuration.

1. A wireless transmit/receive unit (WTRU) comprising:
a processor configured to:
receive information indicating first applicability conditions for a first artificial intelligence or machine learning (AIML) model category and second applicability conditions for a second AIML model category, and a first configuration associated with the first AIML model category and a second configuration associated with the second AIML model category;
determine whether a first AIML model category is applicable to a cell based on the first applicability conditions and the first configuration, and determine whether the second AIML model category is applicable to the cell based on the second applicability conditions and the second configuration;
send a report, wherein the report indicates applicability of the first AIML model category to the cell and indicates the applicability of the second AIML model category to the cell;
determine that the first AIML model category is no longer applicable to the cell based on the first configuration; and
send an indication that indicates that the first AIML model category is no longer applicable to the cell.

2. The WTRU of claim 1, wherein the processor is further configured to:
perform inference using a model of the first AIML category based on the first configuration in response to determining that the first AIML category is applicable to the cell; and
perform inference using a model of the second AIML category based on the second configuration in response to determining that the first AIML category is no longer applicable to the cell.

3. The WTRU of claim 1, wherein the first applicability conditions comprise a first indication of one or more of: a number of Transmission-Reception Points (TRPs), a number of antennas, an antenna tilt, a polarization of an antenna, a beam, a geographic area, or a time-period; and
wherein the second applicability conditions comprise a second indication of one or more of: a number of Transmission-Reception Points (TRPs), a number of antennas, an antenna tilt, a polarization of an antenna, a beam, a geographic area, or a time-period.

4. The WTRU of claim 1, wherein the first AIML model category is associated with a different prediction time horizon, a different prediction confidence level, a different processing requirement, and is configured for a different frequency, a different cell, a different location, or a different time of day as compared to the second AIML model category.

5. The WTRU of claim 1, wherein the report comprises a list of one or more cells in which at least one AIML model category is applicable based on the first configuration or the second configuration.

6. The WTRU of claim 1, wherein the report comprises a request to receive multiple configurations for at least one of the first AIML model category and the second AIML model category, wherein the multiple configurations comprise the first configuration and the second configuration.

7. The WTRU of claim 1, wherein the report comprises an indication of a preference indicating which of the first configuration or the second configuration is to be initially activated and which is to be stored as a fallback configuration.

8. The WTRU of claim 1, wherein the processor is configured to perform AIML inference according to the first configuration until the first AIML model category is determined to be no longer applicable; and
wherein the indication that the first AIML model category is no longer applicable indicates that the WTRU will use the second configuration associated with the second AIML model category.

9. The WTRU of claim 1, wherein the processor is configured to determine that the first AIML model category is no longer applicable based on at least one of mobility of the WTRU to a different cell, a change in network-side applicability conditions, or an update in model availability.

10. The WTRU of claim 1, wherein the first configuration comprises configuration information enabling inference using an AIML model trained on first network conditions; and
wherein the second configuration comprises configuration information enabling inference using an AIML model trained on second network conditions.

11. A method implemented by a wireless transmit/receive unit (WTRU), the method comprising:
receiving information indicating first applicability conditions for a first artificial intelligence or machine learning (AIML) model category and second applicability conditions for a second AIML model category, and a first configuration associated with the first AIML model category and a second configuration associated with the second AIML model category;
determining whether the first AIML model category is applicable to a cell based on the first applicability conditions and the first configuration, and determining whether the second AIML model category is applicable to the cell based on the second applicability conditions and the second configuration;
sending a report, wherein the report indicates applicability of the first AIML model category to the cell and indicates applicability of the second AIML model category to the cell;
determining that the first AIML model category is no longer applicable to the cell based on the first configuration; and
sending an indication that indicates that the first AIML model category is no longer applicable to the cell.

12. The method of claim 11, further comprising:
performing inference using a model of the first AIML category based on the first configuration in response to determining that the first AIML category is applicable to the cell; and
performing inference using a model of the second AIML category based on the second configuration in response to determining that the first AIML category is no longer applicable to the cell.

13. The method of claim 11, wherein the first applicability conditions comprise a first indication of one or more of: a number of Transmission-Reception Points (TRPs), a number of antennas, an antenna tilt, a polarization of an antenna, a beam, a geographic area, or a time-period; and
wherein the second applicability conditions comprise a second indication of one or more of: a number of Transmission-Reception Points (TRPs), a number of antennas, an antenna tilt, a polarization of an antenna, a beam, a geographic area, or a time-period.

14. The method of claim 11, wherein the first AIML model category is associated with a different prediction time horizon, a different prediction confidence level, a different processing requirement, and is configured for a different frequency, cell, location, or time of day as compared to the second AIML model category.

15. The method of claim 11, wherein the report comprises a list of one or more cells in which at least one AIML model category is applicable based on the first configuration or the second configuration.

16. The method of claim 11, wherein the report comprises a request to receive multiple configurations for at least one of the first AIML model category and the second AIML model category, wherein the multiple configurations comprise the first configuration and the second configuration.

17. The method of claim 11, wherein the report comprises an indication of a preference indicating which of the first configuration or the second configuration is to be initially activated and which is to be stored as a fallback configuration.

18. The method of claim 11, further comprising performing AIML inference according to the first configuration until the first AIML model category is determined to be no longer applicable, wherein the indication that the first AIML model category is no longer applicable indicates that the WTRU will use the second configuration associated with the second AIML model category.

19. The method of claim 11, further comprising determining that the first AIML model is no longer applicable based on at least one of mobility of the WTRU to a different cell, a change in network-side applicability conditions, or an update in model availability.

20. The method of claim 11, wherein the first configuration comprises configuration information enabling inference using an AIML model trained on first network conditions, and
wherein the second configuration comprises configuration information enabling inference using an AIML model trained on second network conditions.
